(19) United States
(12) Patent Application Publication
(10) Pub. No.: US 2025/0080706 A1
(43) Pub. Date: Mar. 6, 2025

(54) CORRECTION METHOD, PROJECTOR, AND NON-TRANSITORY COMPUTER-READABLE STORAGE MEDIUM

(71) Applicant: SEIKO EPSON CORPORATION, Tokyo (JP)

(72) Inventor: Shiki FURUI, Matsumoto-shi (JP)

(73) Assignee: SEIKO EPSON CORPORATION, Tokyo (JP)

(21) Appl. No.: 18/819,713

(22) Filed: Aug. 29, 2024

(30) Foreign Application Priority Data
Aug. 30, 2023 (JP) 2023-140335

(51) Int. Cl. H04N 9/31; G01B 11/25

(52) U.S. Cl. CPC H04N 9/3185; G01B 11/2513; H04N 9/3194

(57) ABSTRACT

A correction method includes obtaining a normal vector of a screen surface, obtaining a first vector orthogonal to both a gravity vector obtained from output of an acceleration sensor associated with a coordinate system of an optical device of a projector and the normal vector, obtaining a second vector orthogonal to the first vector in the screen surface, and obtaining a correction parameter for correction of a shape of a projected image projected on the screen surface based on the first vector and the second vector.

The present application is based on, and claims priority from JP Application Serial Number 2023-140335, filed Aug. 30, 2023, the disclosure of which is hereby incorporated by reference herein in its entirety.

### BACKGROUND

### 1. Technical Field

The present disclosure relates to a correction method, a projector, and a non-transitory computer-readable storage medium.

### 2. Related Art

For example, WO 2017/169186 discloses an image projection system including an estimation unit that estimates an inclination of a projection display apparatus relative to a projection plane based on a projection azimuth angle detected by a first azimuth angle detection unit, an imaging azimuth angle detected by a second azimuth angle detection unit, and a captured image acquired by an imaging apparatus, and a correction unit that corrects a shape of a projection screen based on the inclination of the projection display apparatus estimated by the estimation unit.

WO 2017/169186 is an example of the related art.

When the projection plane is inclined obliquely with respect to gravity direction, it is necessary to consider an inclination of the projection plane for correct calculation of a roll angle for correcting the shape of the projection screen, however, this is not considered in WO 2017/169186.

### SUMMARY

A correction method according to an aspect of the present disclosure includes obtaining a normal vector of a screen surface, obtaining a first vector orthogonal to both a gravity vector obtained from output of an acceleration sensor associated with a coordinate system of an optical device of a projector and the normal vector, obtaining a second vector contained in the screen surface and being orthogonal to the first vector, and obtaining a correction parameter for correction of a shape of a projected image projected on the screen surface based on the first vector and the second vector.

A projector according to another aspect of the present disclosure includes an optical device, and one or more processors, and the one or more processors execute obtaining a normal vector of a screen surface, obtaining a first vector orthogonal to both a gravity vector obtained from output of an acceleration sensor associated with a coordinate system of the optical device and the normal vector, obtaining a second vector contained in the screen surface and being orthogonal to the first vector, and obtaining a correction parameter for correction of a shape of a projected image projected on the screen surface based on the first vector and the second vector.

A non-transitory computer-readable storage medium storing a program according to an aspect of the present disclosure, the program is for controlling a computer to execute obtaining a normal vector of a screen surface, obtaining a first vector orthogonal to both a gravity vector obtained from output of an acceleration sensor associated with a coordinate system of an optical device of a projector and the normal vector, obtaining a second vector contained in the screen surface and being orthogonal to the first vector, and obtaining a correction parameter for correction of a shape of a projected image projected on the screen surface based on the first vector and the second vector.

### BRIEF DESCRIPTION OF THE DRAWINGS

FIG. 1 shows an overview of a system used for a correction method according to a first embodiment.

FIG. 2 is a block diagram of a projector according to the first embodiment.

FIG. 3 is a flowchart showing a flow of the correction method according to the first embodiment.

FIG. 4 is a diagram for explanation of a pitch angle, a yaw angle, and a roll angle of the projector.

FIG. 5 is a diagram for explanation of a relationship between an attitude of the projector and output of an acceleration sensor.

FIG. 6 is a diagram for explanation of a relationship between a gravity vector and the pitch angle.

FIG. 7 is a diagram for explanation of a relationship between the gravity vector and the roll angle.

FIG. 8 is a diagram for explanation of a roll angle obtained using a method of related art based on the output of the acceleration sensor.

FIG. 9 is a diagram for explanation of a roll angle obtained using another method of related art based on the output of the acceleration sensor.

FIG. 10 is a diagram for explanation of a relationship between a normal vector of a screen surface and the gravity vector.

FIG. 11 is a diagram for explanation of three-dimensional coordinates of the screen surface.

FIG. 12 is a diagram for explanation of a plane representing the screen surface and the normal vector of the screen surface.

FIG. 13 is a diagram for explanation of acquisition of the gravity vector.

FIG. 14 is a diagram for explanation of a first vector and a second vector.

FIG. 15 is a diagram for explanation of a vector obtained by normalization of the normal vector of the screen surface, the first vector, and the second vector.

FIG. 16 is a diagram for explanation of an example of keystone distortion correction.

FIG. 17 is a diagram for explanation of horizontal vanishing points and vertical vanishing points in an optical device.

FIG. 18 is a diagram for explanation of determination of a corrected shape.

FIG. 19 is a block diagram of a projector according to a second embodiment.

FIG. 20 is a flowchart showing a flow of a correction method according to the second embodiment.

FIG. 21 is a block diagram of a projector according to a third embodiment.

### DESCRIPTION OF EMBODIMENTS

As below, preferred embodiments according to the present disclosure will be explained with reference to the accompanying drawings. Note that, in the drawings, dimensions and scales of the respective parts are different from real ones as appropriate. Some parts are schematically shown for facilitate understanding. The scope of the present disclosure is not limited to these embodiments without particular description to limit the present disclosure in the following explanation.

### 1. First Embodiment

### 1-1. Overview of System Used for Correction Method

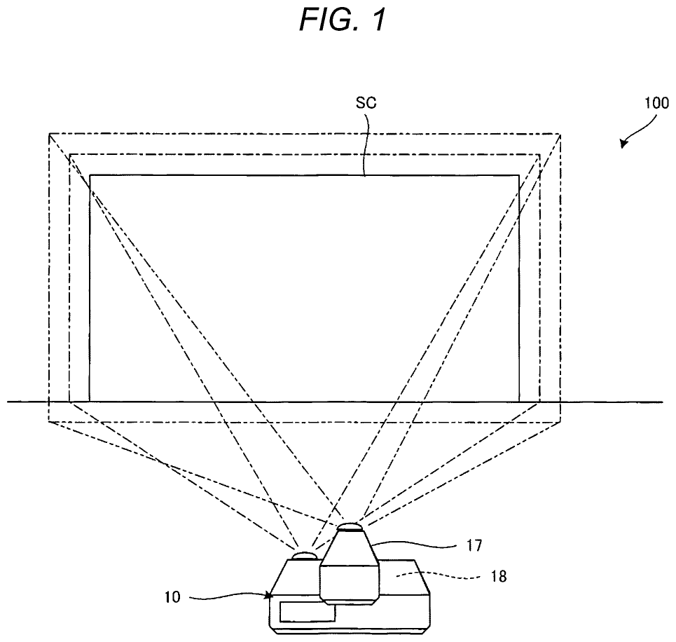

FIG. 1 shows an overview of a system 100 used for a correction method according to a first embodiment. As shown in FIG. 1, the system 100 includes a projector 10.

The projector 10 is a display apparatus that projects an image represented by image information output from an apparatus such as a computer (not shown) onto a screen surface SC. The screen surface SC is a surface of an object such as a screen, and is generally a flat surface. The screen surface SC may not be strictly flat, but may be any surface that can be regarded as a flat surface.

An installation attitude of the screen surface SC may differ depending on the use condition of the system 100 or the like. Accordingly, the projector 10 corrects distortion of a projected image according to the installation attitude of the screen surface SC by keystone correction. As will be described in detail later, the projector 10 includes a camera 17 and an acceleration sensor 18, and has a function of measuring a shape of the screen surface SC using the camera 17, a function of acquiring a gravity vector using the acceleration sensor 18, and a function of obtaining a correction parameter for keystone correction based on the shape of the screen surface SC and the gravity vector.

### 1-2. Projector

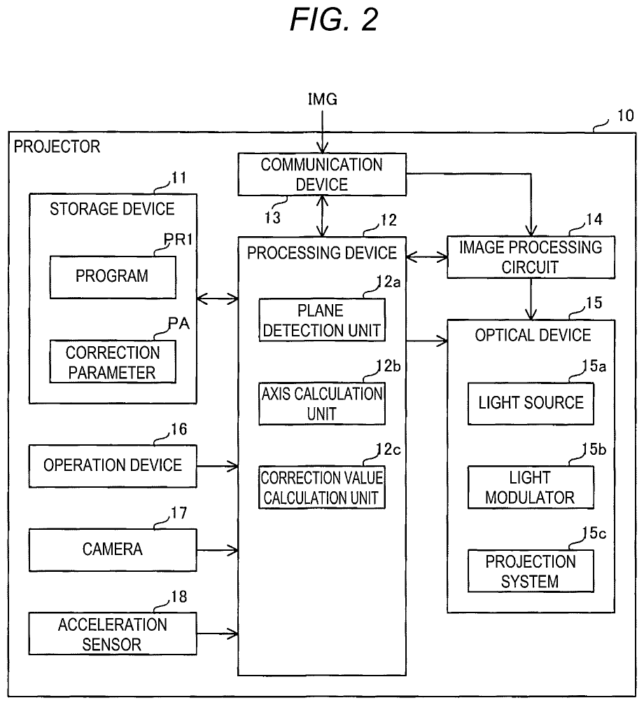

FIG. 2 is a block diagram of the projector 10 according to the first embodiment. As shown in FIG. 2, the projector 10 includes a storage device 11, a processing device 12, a communication device 13, an image processing circuit 14, an optical device 15, an operation device 16, the camera 17, and the acceleration sensor 18. The storage device 11, the processing device 12, the communication device 13, the image processing circuit 14, and the acceleration sensor 18 are disposed inside a housing (not shown) of the projector 10. These devices are communicably connected to one another.

The storage device 11 is a storage device that stores a program executed by the processing device 12 and data processed by the processing device 12. The storage device 11 includes, for example, a hard disk drive or a semiconductor memory. Part or all of the storage device 11 may be provided in a storage device, a server, or the like outside the projector 10.

The storage device 11 stores a program PR1 and a correction parameter PA.

The program PR1 is a program for execution of the correction method, which will be described in detail later. The correction parameter PA is a parameter indicating a degree of correction in distortion correction processing in the image processing circuit 14, and is generated by a correction value calculation unit 12c, which will be described later.

The processing device 12 is a processing device having a function of controlling the individual units of the projector 10 and a function of processing various data. For example, the processing device 12 includes a processor such as a CPU (Central Processing Unit). The processing device 12 may be configured with a single processor or may be configured with a plurality of processors. Part or all of the functions of the processing device 12 may be implemented by hardware such as a DSP (Digital Signal Processor), an ASIC (Application Specific Integrated Circuit), a PLD (Programmable Logic Device), or an FPGA (Field Programmable Gate Array). The processing device 12 may be integrated with the image processing circuit 14.

The communication device 13 is a communication device that can communicate with various apparatuses, and acquires image data IMG from an apparatus (not shown). For example, the communication device 13 is a wired communication device of a wired LAN (Local Area Network), a USB (Universal Serial Bus), or an HDMI (High Definition Multimedia Interface) or a wireless communication device of an LPWA (Low Power Wide Area), a wireless LAN including Wi-Fi, or Bluetooth. Each of “HDMI”, “Wi-Fi”, and “Bluetooth” is a registered trademark.

The image processing circuit 14 is a circuit that performs necessary processing on the image data IMG from the communication device 13 and inputs the data to the optical device 15. The image processing circuit 14 includes, for example, a frame memory (not shown), loads the image data IMG into the frame memory, appropriately executes various kinds of processing such as resolution conversion processing, resizing processing, and distortion correction processing, and inputs the data to the optical device 15. Here, the above described correction parameter PA is used for the distortion correction processing. Note that the image processing circuit 14 may execute processing such as OSD (On Screen Display) processing of generating image information for menu display, operation guidance, or the like and combining the information with the image data IMG as appropriate.

The optical device 15 is a device that displays an image by projecting an image light onto a projection region RP. The optical device 15 includes a light source 15a, a light modulator 15b, and a projection system 15c.

The light source 15a includes light sources such as, for example, halogen lamps, xenon lamps, ultra-high pressure mercury lamps, LEDs (Light Emitting Diodes), or laser beam sources and respectively emit a red light, a green light, and a blue light. The light modulator 15b includes three light modulation elements provided to correspond to red, green, and blue. Each of the light modulation elements includes, for example, a transmissive liquid crystal panel, a reflective liquid crystal panel, a DMD (digital mirror device), or the like, and generates an image light of each color by modulating the corresponding color light. The image lights of the individual colors generated by the light modulator 15b are combined by a light combining system to be a full-color image light. The projection system 15c is an optical system including a projection lens that forms and projects the full-color image light from the light modulator 15b on the screen surface SC, and the like.

The operation device 16 is a device that receives an operation from the user. For example, the operation device 16 includes an operation panel and a remote control receiver (not shown). The operation panel is provided in an exterior housing of the projector 10 and outputs a signal according to an operation from the user. The remote control receiver receives an infrared signal from a remote controller (not shown), decodes the infrared signal, and outputs a signal according to the operation of the remote controller. The operation device 16 may be provided as necessary or omitted.

The camera 17 is a digital camera including an imaging device such as a CCD (Charge Coupled Device) or a CMOS (Complementary Metal Oxide Semiconductor).

The acceleration sensor 18 is a sensor that detects an acceleration applied to the projector 10. The acceleration sensor 18 is provided in the projector 10 and fixed to a predetermined position in the housing of the projector 10. The predetermined position is, for example, on a circuit board (not shown) on which the processing device 12 is mounted. The acceleration sensor 18 outputs signals according to accelerations in directions along the respective axes of an x-axis, a y-axis, and a z-axis, which will be described later, associated with a coordinate system of the optical device 15 of the projector 10. The acceleration sensor 18 is fixed to the predetermined position in the housing of the projector 10, and the position within the housing is specified. That is, the relative positional relationship between the acceleration sensor 18 and the optical device 15 is specified in advance. Thereby, the acceleration sensor 18 is associated with the coordinate system of the optical device 15.

In the above described projector 10, the processing device 12 functions as a plane detection unit 12a, an axis calculation unit 12b, and the correction value calculation unit 12c by executing the program PR1 stored in the storage device 11. Accordingly, the processing device 12 includes the plane detection unit 12a, the axis calculation unit 12b, and the correction value calculation unit 12c.

The plane detection unit 12a controls operations of the optical device 15 and the camera 17 to obtain a plane representing the screen surface SC. Specifically, the plane detection unit 12a obtains the plane representing the screen surface SC based on an image obtained by imaging of a measurement pattern PT, which will be described later, projected onto the screen surface SC.

The axis calculation unit 12b obtains the axis x and the axis y, which will be described later, as coordinate axes of the screen surface SC based on the plane obtained by the plane detection unit 12a and the output of the acceleration sensor 18. Specifically, the axis calculation unit 12b obtains a normal vector N, which will be described later, of the screen surface SC based on the plane obtained by the plane detection unit 12a. Further, the axis calculation unit 12b obtains a vector X, which will be described later, orthogonal to both a gravity vector G, which will be described later, obtained from the output of the acceleration sensor 18 and the normal vector N. The vector X is an example of “first vector”. Furthermore, the axis calculation unit 12b obtains a vector Y, which will be described later, orthogonal to the vector X in the screen surface SC. The vector Y is an example of “second vector”. The vector Y is a vector contained in the screen surface SC.

The correction value calculation unit 12c obtains the correction parameter PA for correction of the shape of a projected image projected on the screen surface SC based on the vector X and the vector Y to be described later obtained by the axis calculation unit 12b.

### 1-3. Correction Method

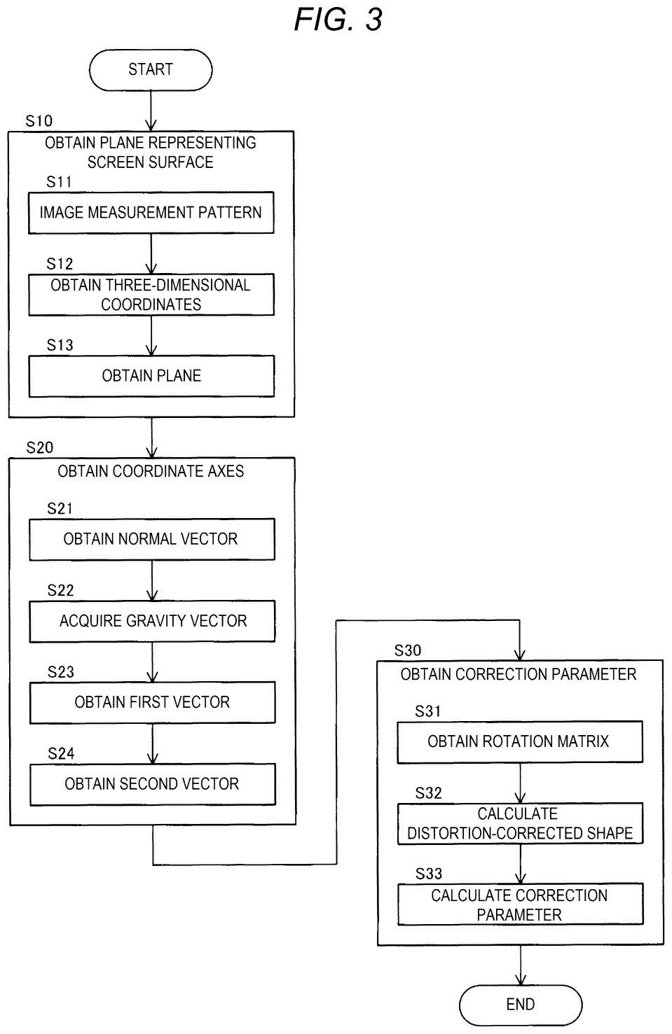

FIG. 3 is a flowchart showing a flow of the correction method according to the first embodiment. The correction method is executed by the above described projector 10.

As shown in FIG. 3, the correction method of the embodiment includes step S10, step S20, and step S30 in this order.

At step S10, the plane detection unit 12a controls the operation of the optical device 15 and the camera 17 to obtain a plane representing the screen surface SC.

Specifically, step S10 includes step S11, step S12, and step S13 in this order. At step S11, the plane detection unit 12a images the measurement pattern PT to be described later projected on the screen surface SC. At step S12, the plane detection unit 12a obtains coordinates on the screen surface SC based on the image captured at step S11. At step S13, the plane detection unit 12a obtains the plane representing the screen surface SC based on the coordinates obtained at step S12.

At step S20, the axis calculation unit 12b obtains the axis x and the axis y to be described later as the coordinate axes of the screen surface SC based on the plane obtained by the plane detection unit 12a and the output of the acceleration sensor 18.

Specifically, step S20 includes step S21, step S22, step S23, and step S24 in this order. At step S21, the axis calculation unit 12b obtains the normal vector N to be described later of the screen surface SC based on the plane obtained at step S10. At step S22, the axis calculation unit 12b acquires the gravity vector G to be described later obtained from the output of the acceleration sensor 18. At step S23, the axis calculation unit 12b obtains the vector X to be described later orthogonal to both the gravity vector G acquired at step S22 and the normal vector N. At step S23, the axis calculation unit 12b obtains the vector Y to be described later orthogonal to the vector X on the screen surface SC.

At step S30, the correction value calculation unit 12c obtains the correction parameter PA for correction of the shape of the projected image projected on the screen surface SC based on the vector X and the vector Y to be described later obtained in step S20.

Specifically, step S30 includes step S31, step S32, and step S33 in this order. At step S31, the correction value calculation unit 12c obtains a matrix R, which will be described later, for conversion of the coordinate system of the optical device 15 of the projector 10 into the coordinate system on the screen surface SC. At step S32, the correction value calculation unit 12c calculates a corrected shape using the matrix R obtained at step S31. At step S33, the correction value calculation unit 12c obtains the correction parameter PA based on the corrected shape obtained at step S32.

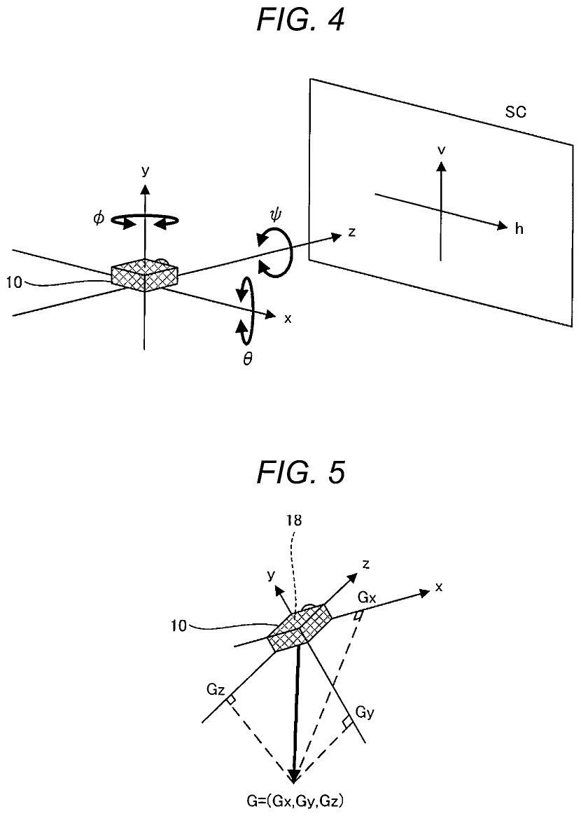

FIG. 4 is a diagram for explanation of a pitch angle θ, a yaw angle φ, and a roll angle ψ of the projector 10. As shown in FIG. 4, in the projector 10, the x-axis, the y-axis, and the z-axis are set as three axes orthogonal to one another. The x-axis is an axis extending along a width direction of the projector 10. The y-axis is an axis extending along a height direction of the projector 10. The z-axis is an axis along a projection direction of the projector 10. The z-axis is an example of “first axis” as an optical axis of the projection lens. The y-axis is an example of “second axis” orthogonal to the first axis. The x-axis is an example of “third axis” orthogonal to both the first axis and the second axis.

Here, the attitude of the projector 10 is expressed by the pitch angle θ as a rotation angle around the x-axis of the projector 10, the yaw angle φ as a rotation angle around the y-axis of the projector 10, and the roll angle θ as a rotation angle around the z-axis of the projector 10.

In the example shown in FIG. 4, the y-axis is parallel to the gravity direction. The x-axis and the z-axis are each parallel to a horizontal plane. Further, a horizontal axis h along the lateral direction of the screen surface SC is parallel to the horizontal surface, and a vertical axis v along the longitudinal direction of the screen surface SC is parallel to the gravity direction. Here, when the z-axis is orthogonal to the screen surface SC, the x-axis is parallel to the horizontal axis h, and the y-axis is parallel to the vertical axis v.

FIG. 5 is a diagram for explanation of a relationship between the attitude of the projector 10 and the output of the acceleration sensor 18. The acceleration sensor 18 is a triaxial acceleration sensor, and outputs signals according to accelerations in directions respectively along the x-axis, the y-axis, and the z-axis. The triaxial output from the acceleration sensor 18 indicates three components of the gravity vector G applied to the projector 10 when the projector 10 is installed.

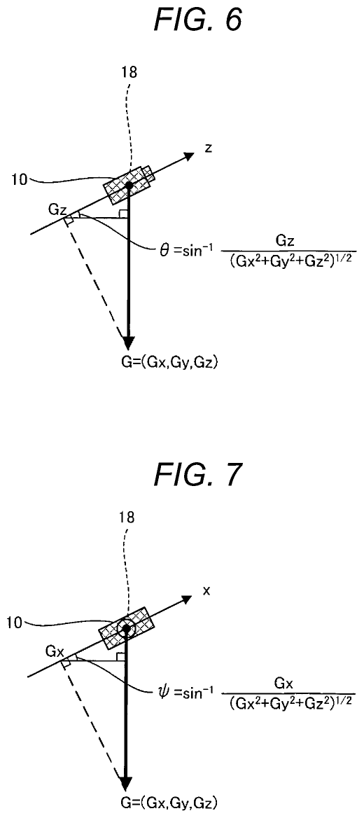

FIG. 6 is a diagram for explanation of a relationship between the gravity vector G and the pitch angle θ. FIG. 7 is a diagram for explanation of a relationship between the gravity vector G and the roll angle ψ. When the screen surface SC is perpendicular to the plane with the gravity vector G as the normal vector, as shown in FIG. 6, the pitch angle θ can be obtained based on output values (Gx, Gy, Gz) of the acceleration sensor 18, that is, the gravity vector G. In this case, as shown in FIG. 7, the roll angle ψ can be obtained based on the output values (Gx, Gy, Gz) of the acceleration sensor 18, that is, the gravity vector G.

However, since the yaw angle φ is not related to the gravity vector G, the yaw angle φ is not obtained based on the output values (Gx, Gy, Gz) of the acceleration sensor 18.

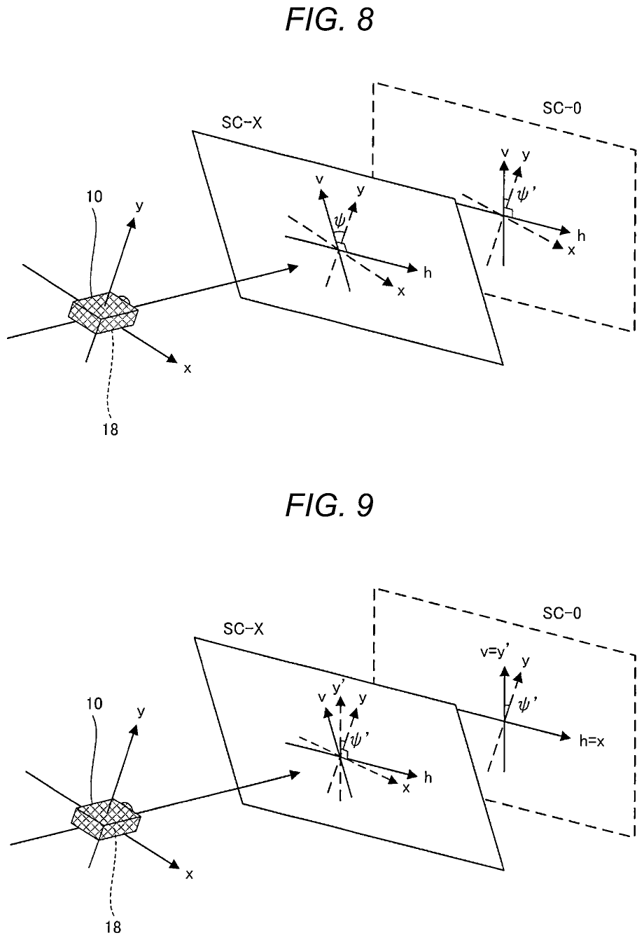

FIG. 8 is a diagram for explanation of a roll angle ψ obtained using a method of related art based on the output of the acceleration sensor 18. In FIG. 8, the screen surface SC perpendicular to the plane with the gravity vector G as the normal vector is shown by a broken line as a screen surface SC-0, and the screen surface SC not perpendicular to the plane with the gravity vector G as the normal vector is shown by a solid line as a screen surface SC-X.

As shown in FIG. 8, the roll angle ψ of an actual image in the screen surface SC-X is different from a roll angle ψ′ obtained based on the output values of the acceleration sensor 18 as described above. Here, the roll angle ψ of the image in the screen surface SC-X is an angle formed by the vertical axis v of the screen surface SC-X and the y-axis of the projector 10. As described above, when the screen surface SC is not perpendicular to the plane with the gravity vector G as the normal vector, there is a problem that the roll angle ψ and the roll angle ψ′ are different. Although not shown, the pitch angle θ also has the same problem.

FIG. 9 is a diagram for explanation of the roll angle ψ obtained using another method of related art based on the output of the acceleration sensor 18. In the other method of related art, a relative attitude relationship between the projector 10 and the screen surface SC is directly measured using a TOF (Time Of Flight) sensor. The correct pitch angle θ and yaw angle φ can be obtained using the measurement result. However, the measurement result contains no information on the roll angle ψ. Accordingly, it is necessary to obtain the roll angle ψ based on the output values of the acceleration sensor 18.

As described above, in the screen surface SC-0 perpendicular to the plane with the gravity vector G as the normal vector, an angle formed by the y-axis of the projector 10 and the vertical axis v of the screen surface SC-0 is equal to the roll angle ψ obtained from the output of the acceleration sensor 18. Therefore, first, the y-axis of the projector 10 is used as a tentative y-axis of the screen surface SC-0 and the tentative y-axis is rotated by the roll angle ψ′ obtained from the output of the acceleration sensor 18, and thereby, the y-axis after roll correction of the screen surface SC-0 is obtained. Then, an axis perpendicular to the y-axis after the roll correction can be obtained as the x-axis of the screen surface SC0.

However, in the screen surface SC-X not perpendicular to the plane with the gravity vector G as the normal vector, the angle formed by the y-axis of the projector 10 and the vertical axis v of the screen surface SC-X is not equal to the roll angle ψ obtained from the output of the acceleration sensor 18. Therefore, in the other method, the correct x-axis and y-axis of the screen surface SC-X are not obtained. As a result, the image rotated in a roll direction is projected within the screen surface SC-X.

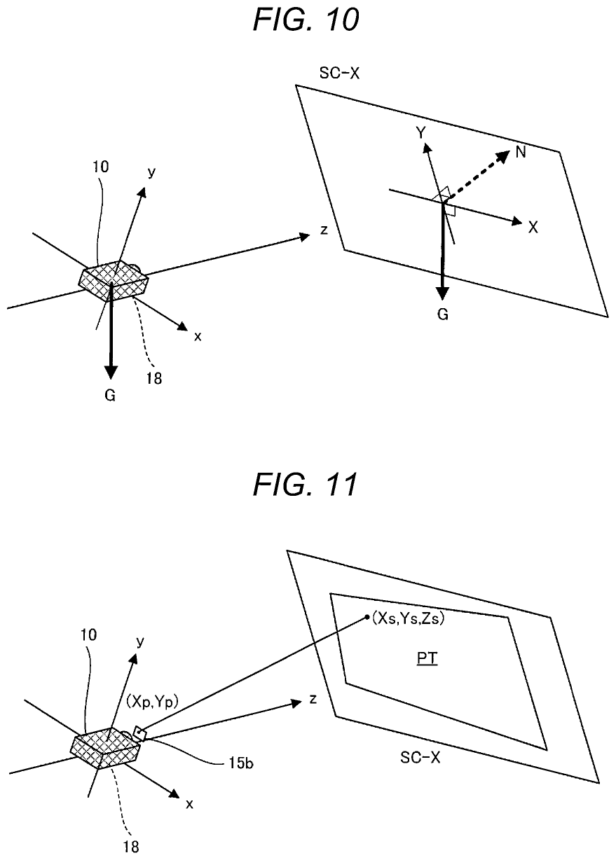

FIG. 10 is a diagram for explanation of a relationship between the normal vector N of the screen surface SC-X and the gravity vector G. As shown in FIG. 10, a vector X indicating the x-axis and a vector Y indicating the y-axis on the screen surface SC-X can be obtained based on the normal vector N of the screen surface SC-X and the gravity vector G. The vector X is an example of “first vector”. The vector Y is an example of “second vector”.

Here, the x-axis of the screen surface SC-X is determined so that the vector X indicating the x-axis and the gravity vector G are perpendicular to each other. The y-axis of the screen surface SC-X is determined so that the vector Y indicating the y-axis, the normal vector N of the screen surface SC-X, and the gravity vector G are in the same plane.

More specifically, for example, using an outer product of vectors, from the relationships X=N×G and Y=N×X=N×(N×G), the vector X and the vector Y can be obtained.

The x-axis and the y-axis on the screen surface SC-X are obtained as described above, and thereby, the image may be corrected in the roll direction regardless of the attitude of the projector 10 and the attitude of the screen surface SC.

FIG. 11 is a diagram for explanation of three-dimensional coordinates (Xs, Ys, Zs) of the screen surface SC-X. At the above described step S11, the plane detection unit 12a controls the operation of the projector 10 to sequentially project a plurality of measurement patterns PT on the screen surface SC, and controls the operation of the camera 17 to image the individual measurement patterns PT projected on the screen surface SC. Thereby, a plurality of captured images obtained by imaging of the measurement patterns PT by the camera 17 are obtained.

As the measurement pattern PT, for example, a binary code pattern is used. The binary code pattern refers to an image for expressing coordinates of a display apparatus using a binary code. The binary coding is a technique, when any numerical value is expressed by a binary number, a value of each digit is expressed with on and off of a switch. When a binary code pattern is used as the measurement pattern PT, an image projected by the projector 10 corresponds to the switch, and the measurement patterns PT in the number equivalent to the number of digits of a binary number expressing a coordinate value are required. Further, separate measurement patterns PT are respectively required for a coordinate in the longitudinal direction and a coordinate in the lateral direction. For example, when the resolution (number of pixels) of the optical device 15 of the projector 10 is 120×90, since each of 120 and 90 is expressed by a binary number of seven digits, seven images are required to express the coordinate in the longitudinal direction and seven images are required to express the coordinate in the lateral direction.

When the binary code pattern is used as the measurement pattern PT, generally, the robustness of measurement is reduced due to the influence of disturbance light including illumination. Accordingly, when the binary code pattern is used as the measurement pattern PT, it is preferable to use a complementary pattern in combination from the viewpoint of suppression of the influence of disturbance light and improvement of the robustness of measurement. The complementary pattern refers to an image in which black and white are reversed.

Note that the measurement pattern PT is not limited to the binary code pattern, but may be other structured light such as a dot pattern, a rectangular pattern, a polygonal pattern, a checker pattern, a gray code pattern, a phase shift pattern, or a random dot pattern.

At the above described step S12, the plane detection unit 12a measures the screen surface SC based on the plurality of captured images. Here, at step S12, the correspondence relationship between the coordinates (Xc, Yc) in the coordinate system of the captured image of the camera 17 and the coordinates (Xp, Yp) in the coordinate system of the optical device 15 of the projector 10 is obtained, and then, three-dimensional coordinates of the respective portions of the measurement pattern PT projected on the screen surface SC-X are obtained from the correspondence relationship. Thereby, with respect to the coordinates (Xp, Yp) of each point in the coordinate system of the optical device 15, the three-dimensional coordinates (Xs, Ys, Zs) of each point on the screen surface SC-X on which each point is projected are obtained.

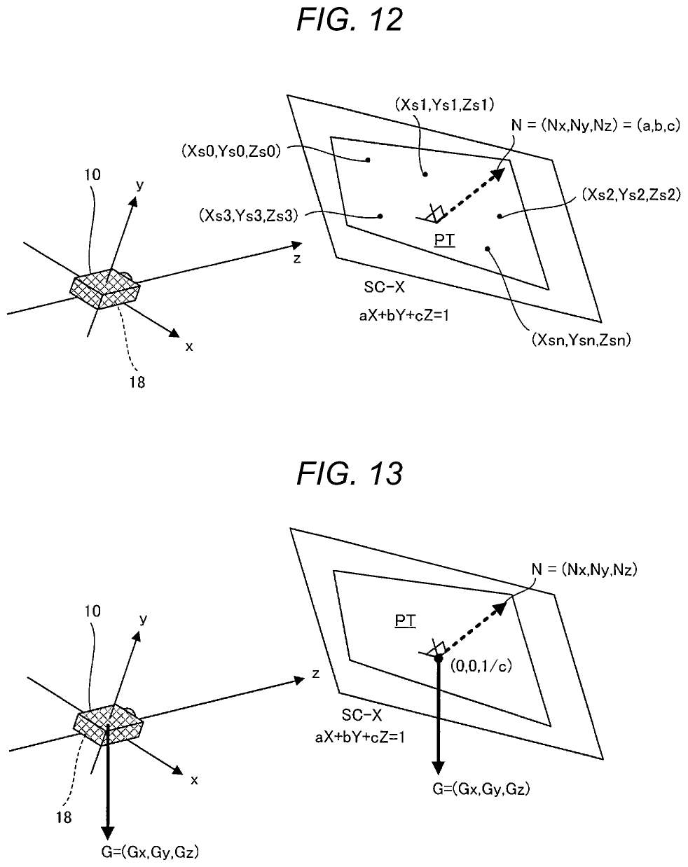

FIG. 12 is a diagram for explanation of a plane representing the screen surface SC-X and the normal vector N of the screen surface SC-X. As shown in FIG. 12, at the above described step S12, the coordinates (Xs0, Ys0, Zs0), (Xs1, Ys1, Zs1), . . . , (Xsn, Ysn, Zsn) of the n points on the screen surface SC-X on which the measurement pattern PT is projected are obtained as the three-dimensional coordinates (Xs, Ys, Zs).

At step S13, the plane detection unit 12a obtains an equation of the plane representing the screen surface SC-X by obtaining an equation aX+bY+cZ=1 of the plane passing through the n points.

As described above, at step S10, the plane representing the screen surface SC-X is obtained. After step S10, step S20 is executed.

At step S20, first, at step S21, the axis calculation unit 12b obtains the normal vector N=(Nx, Ny, Nz)=(a, b, c) of the screen surface SC-X based on the equation obtained at step S13.

FIG. 13 is a diagram for explanation of acquisition of the gravity vector G. At step S22, as shown in FIG. 13, the axis calculation unit 12b acquires the gravity vector G=(Gx, Gy, Gz) applied to the projector 10 from the output values of the acceleration sensor 18. Here, the same gravitational acceleration is applied to the screen surface SC-X, and the gravity vector of the screen surface SC-X is also G=(Gx, Gy, Gz).

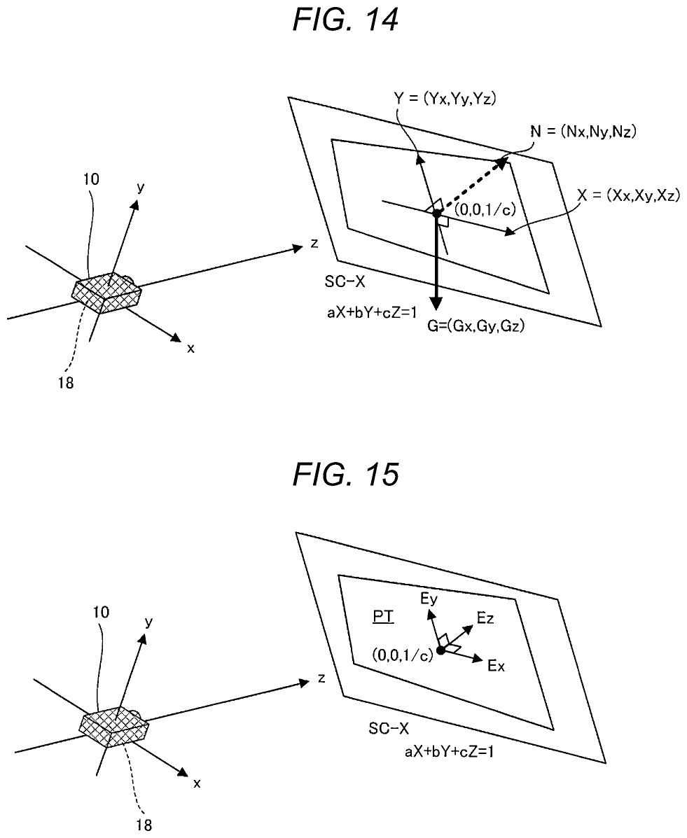

FIG. 14 is a diagram for explanation of the vector X and the vector Y. At step S23, as shown in FIG. 13, the axis calculation unit 12b obtains a vector X orthogonal to both the normal vector N=(Nx, Ny, Nz) of the screen surface SC-X and the gravity vector G=(Gx, Gy, Gz). Here, for example, a vector X=N×G is obtained from an outer product of the normal vector N and the gravity vector G. The method of calculating the vector X is not limited to the method using the outer product, but may be, for example, a method of obtaining the vector X from a line of intersection between a plane orthogonal to the normal vector N and a plane orthogonal to the gravity vector G.

At step S24, the axis calculation unit 12b obtains a vector Y orthogonal to both the normal vector N and the vector X. Here, for example, a vector Y=N×X=N×(N×G) is obtained from an outer product of the normal vector N and the vector X.

The vectors X and Y are obtained as described above, and thereby, at step S30, proper correction in the roll direction may be performed using the vectors X and Y so that the x-axis is aligned with the horizontal axis h and the y-axis is aligned with the vertical axis v on the screen surface SC-X.

FIG. 15 is a diagram for explanation of vectors Ex, Ey, Ez obtained by normalization of the normal vector N, the vector X, and the vector Y of the screen surface SC-X. At step S31, the correction value calculation unit 12c first normalizes each of the vector X=(Xx, Xy, Xz) expressing the x-axis of the screen surface SC-X, the vector Y=(Yx, Yy, Yz) expressing the y-axis, and the normal vector N=(Nx, Ny, Nz) to a length “1”, and thereby, obtains the vectors Ex, Ey, Ez as an orthonormal basis appropriately roll-corrected with respect to the gravity on the screen surface SC-X.

When a 3×3 matrix in which the three vectors Ex, Ey, Ez are transposed and arranged horizontally is R, the matrix R is a rotation matrix from the coordinate system of the optical device 15 of the projector 10 to the coordinate system on the screen surface SC-X as expressed by the following expression.

$$Ex = ( {E}_{11} , {E}_{21} , {E}_{31} ) = \frac{X}{‖ X ‖} = \frac{1}{\sqrt{{Xx}^{2} + {Xy}^{2} + {Xz}^{2}}} ( Xx , Xy , Xz )$$

$$Ey = ( {E}_{12} , {E}_{22} , {E}_{32} ) = \frac{Y}{‖ Y ‖} = \frac{1}{\sqrt{{Yx}^{2} + {Yy}^{2} + {Yz}^{2}}} ( Yx , Yy , Yz )$$

$$Ez = ( {E}_{13} , {E}_{23} , {E}_{33} ) = \frac{N}{‖ N ‖} = \frac{1}{\sqrt{{Nx}^{2} + {Ny}^{2} + {Nz}^{2}}} ( Nx , Ny , Nz )$$

$$R = ( \begin{matrix}{Ex}^{T} & {Ey}^{T} & {Ez}^{T}\end{matrix} ) = ( \begin{matrix}{E}_{11} & {E}_{12} & {E}_{13} \\ {E}_{21} & {E}_{22} & {E}_{23} \\ {E}_{31} & {E}_{32} & {E}_{33}\end{matrix} )$$

In this manner, at step S31, the correction value calculation unit 12c obtains the matrix R as the rotation matrix using the three vectors Ex, Ey, Ez.

When standard basis vectors of the coordinate system of the optical device 15 of the actual projector 10 are e_X=(1, 0, 0), e_Y=(0, 1, 0), and e_Z=(0, 0, 1), these vectors are transformed by the matrix R to the vectors Ex, Ey, Ez as an orthonormal basis on the screen surface SC-X as expressed by the following expression.

$$R {e}_{x}^{T} = R ( \begin{matrix}1 \\ 0 \\ 0\end{matrix} ) = ( \begin{matrix}{E}_{11} \\ {E}_{21} \\ {E}_{31}\end{matrix} ) = {Ex}^{T}$$

$$R {e}_{y}^{T} = R ( \begin{matrix}0 \\ 1 \\ 0\end{matrix} ) = ( \begin{matrix}{E}_{12} \\ {E}_{22} \\ {E}_{32}\end{matrix} ) = {Ey}^{T}$$

$$R {e}_{z}^{T} = R ( \begin{matrix}0 \\ 0 \\ 1\end{matrix} ) = ( \begin{matrix}{E}_{13} \\ {E}_{23} \\ {E}_{33}\end{matrix} ) = {Ez}^{T}$$

In this manner, the matrix R is a rotation matrix representing the rotation of the screen surface SC-X such that the roll viewed from the projector 10 in the projection direction is properly corrected.

The matrix R is obtained as described above, and thereby, at step S32, the corrected shape SH can be calculated using a known keystone distortion correction method using the matrix R. An example of calculation of a distortion-corrected shape at step S32 will be described as below.

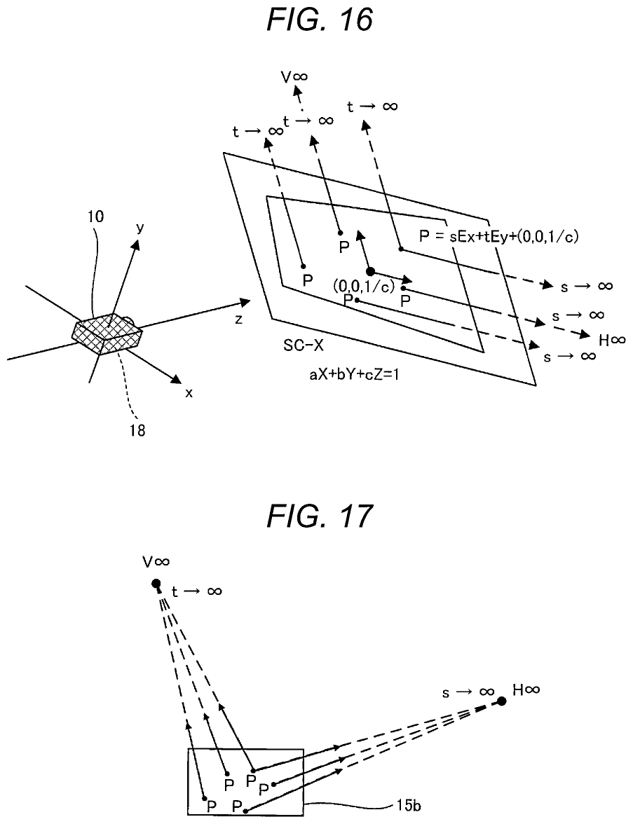

FIG. 16 is a diagram for explanation of an example of keystone distortion correction. FIG. 16 shows a method using coordinates of vanishing points on the optical device 15 as the example of keystone distortion correction. The vanishing points are at coordinates on the optical device 15 when points at infinity in the vertical direction and the horizontal direction on the screen surface SC-X are viewed from the projector 10.

The matrix R represents the rotation of the screen surface SC-X with respect to the projector 10. When the coordinates of the origin of the screen surface SC-X are (0, 0, 1/c), a certain point P on the screen surface SC-X is expressed by the following expression using two parameters s and t.

$$P = ( X , Y , Z ) = s Ex + t Ey + ( 0 , 0 , \frac{1}{c} ) = ( s {E}_{11} + t {E}_{12} , s {E}_{21} + t {E}_{22} , s {E}_{31} + t {E}_{32} , + \frac{1}{c} )$$

Of the points P, a point indicated by s→^{∞} is a horizontal point at infinity and a point indicated by t→^{∞} is a vertical point at infinity.

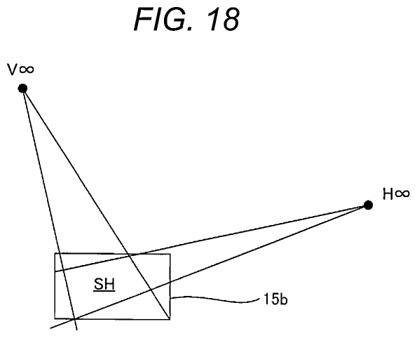

FIG. 17 is a diagram for explanation of horizontal vanishing points and vertical vanishing points in the optical device 15.

A point p on the optical device 15 corresponding to the point P is expressed by the following expression.

$$P = ( X , Y , Z ) = s Ex + t Ey + ( 0 , 0 , \frac{1}{c} ) = ( s {E}_{11} + t {E}_{12} , s {E}_{21} + t {E}_{22} , s {E}_{31} + t {E}_{32} , + \frac{1}{c} )$$

The coordinate system of the optical device 15 is not a pixel coordinate system, but the so-called pinhole camera-model standard coordinate system. When an exit point of a projected light is at the origin and the optical device 15 is regarded as a plane Z=1, two components (X, Y) of coordinates (X, Y, 1) on the plane are extracted.

The vanishing point on the optical device 15 is obtained by projection of a point at infinity in the real space on the light modulator 15b of the optical device 15. Accordingly, as expressed by the following expression, of the points p in the coordinate system of the optical device 15, a point indicated by s→^{∞} is a horizontal vanishing point H^{∞} and a point indicated by t→^{∞} is a vertical vanishing point V^{∞}.

$${H}_{∞} = {}_{s \to ∞} ( \frac{s {E}_{11} + t {E}_{12}}{s {E}_{31} + t {E}_{32} , + \frac{1}{c}} , \frac{s {E}_{21} + t {E}_{22}}{s {E}_{31} + t {E}_{32} , + \frac{1}{c}} ) = {}_{s \to ∞} ( \frac{{E}_{11} + \frac{t}{s} {E}_{12}}{{E}_{31} + \frac{t}{s} {E}_{32} , + \frac{1}{cs}} , \frac{{E}_{21} + \frac{t}{s} {E}_{22}}{{E}_{31} + \frac{t}{s} {E}_{32} , + \frac{1}{cs}} ) = ( \frac{{E}_{11}}{{E}_{31}} , \frac{{E}_{21}}{{E}_{31}} )$$

$${V}_{∞} = {}_{t \to ∞} ( \frac{s {E}_{11} + t {E}_{12}}{s {E}_{31} + t {E}_{32} , + \frac{1}{c}} , \frac{s {E}_{21} + t {E}_{22}}{s {E}_{31} + t {E}_{32} , + \frac{1}{c}} ) = {}_{t \to ∞} ( \frac{\frac{s}{t} {E}_{11} + {E}_{12}}{\frac{s}{t} {E}_{31} + {E}_{32} , + \frac{1}{ct}} , \frac{\frac{s}{t} {E}_{21} + {E}_{22}}{\frac{s}{t} {E}_{31} + {E}_{32} , + \frac{1}{ct}} ) = ( \frac{{E}_{12}}{{E}_{32}} , \frac{{E}_{22}}{{E}_{32}} )$$

FIG. 18 is a diagram for explanation of determination of the corrected shape SH. A straight line parallel to the x-axis in the real space (that is, a horizontal straight line) has a property of passing through the horizontal vanishing point H^{∞} on the optical device 15. Similarly, a straight line parallel to the y-axis in the real space (that is, a vertical straight line) has a property of passing through the vertical vanishing point V^{∞} on the optical device 15. In addition, the converse to these properties is also true.

Accordingly, at step S32, the correction value calculation unit 12c obtains the corrected shape SH on the optical device 15 by obtaining each of the upper side and the lower side as a straight line passing through the horizontal vanishing point H^{∞} and each of the left side and the right side as a straight line passing through the vertical vanishing point V^{∞}.

Here, there are several corrected shapes SH with each of the upper side and the lower side passing through the horizontal vanishing point H^{∞} and each of the left side and the right side passing through the vertical vanishing point V^{∞}. The determination of the corrected shape SH is made, for example, by selecting the corrected shape SH having the maximum area, left-aligned, right-aligned, up-aligned, or down-aligned on the optical device 15, having a designated aspect ratio on the projection surface of the screen surface SC-X, or the like for an intended function.

At step S33, the correction value calculation unit 12c obtains a correction parameter PA based on the corrected shape SH obtained at step S32. The obtained correction parameter PA is stored in the storage device 11 as described above and used for keystone correction in the image processing circuit 14. Thereby, the rectangular image roll-corrected so that the y-axis is parallel to the gravity direction is projected on the screen surface SC-X.

As described above, the correction method of the embodiment includes step S21, step S23, step S24, and step S30. At step S21, the normal vector N of the screen surface SC is obtained. At step S23, the vector X orthogonal to both the gravity vector G and the normal vector N obtained from the output of the acceleration sensor 18 associated with the coordinate system of the optical device 15 of the projector 10 is obtained. The vector X is an example of “first vector”. At step S24, the vector Y contained in the screen surface SC and orthogonal to the vector X is obtained. The vector Y is an example of “second vector”. At step S30, the correction parameter PA for correction of the shape of the projected image projected on the screen surface SC is obtained based on the vector X and the vector Y.

Here, the correction method of the embodiment is performed using the projector 10 including the optical device 15 and the processing device 12. The processing device 12 executes step S21, step S23, step S24, and step S30.

The display method of the embodiment is realized by the processing device 12 as an example of “computer” executing the program PR1. The program PR1 are for controlling the processing device 12 to execute step S21, step S23, step S24, and step S30.

The gravity vector G and the normal vector N are used in the above described correction method, projector 10, or program PR1, and thereby, the correction parameter PA in consideration of the inclination of the screen surface SC with respect to the gravity direction may be obtained. As a result, the correction accuracy of the shape of the projected image can be increased.

As described above, the correction method of the embodiment includes step S10. At step S10, the plane representing the screen surface SC is obtained. Then, at step S21, the normal vector N is obtained from the plane of the screen surface SC. Thereby, even when the screen surface SC is not strictly flat, the normal vector N of the screen surface SC can be easily obtained.

As described above, step S10 further includes step S13. At step S13, the plane of the screen surface SC is obtained based on the image obtained by imaging of the measurement pattern PT projected on the screen surface SC. Thereby, the plane representing the screen surface SC can be obtained with high accuracy.

Furthermore, as described above, at step S30, the correction parameter PA is obtained using the normalized vector X and vector Y. Thereby, the aspect ratio of the corrected shape SH can be easily adjusted.

### 2. Second Embodiment

A second embodiment of the present disclosure is described as below. In the embodiment exemplified below, the reference signs used in the description of the first embodiment are used for elements having the same actions and functions as those of the first embodiment, and the detailed description of the individual elements is omitted as appropriate.

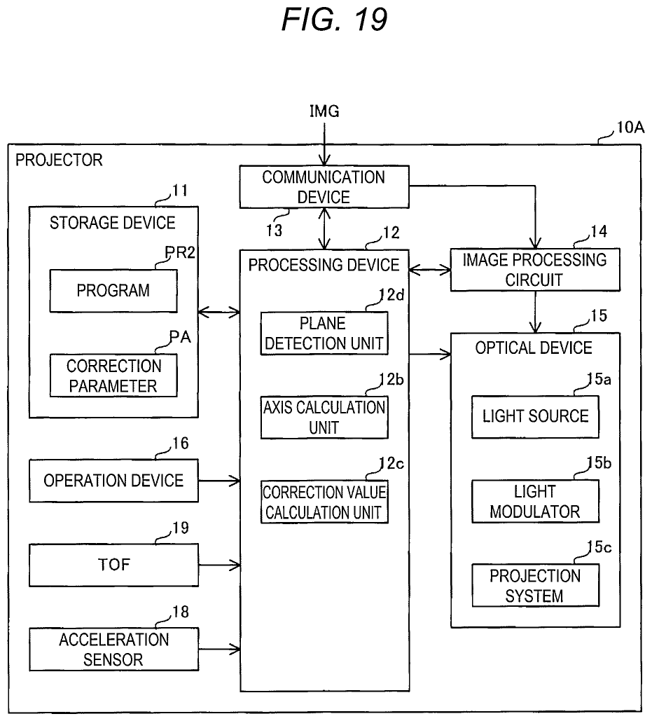

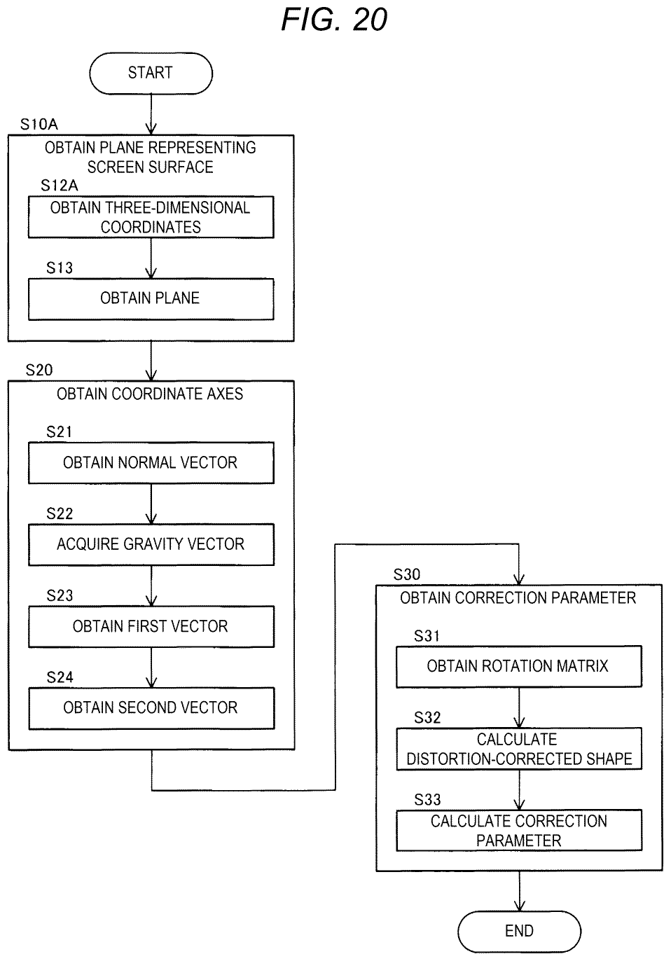

FIG. 19 is a block diagram of a projector 10A according to the second embodiment. The projector 10A has the same configuration as the projector 10 of the first embodiment except that a TOF sensor 19 is provided in place of the camera 17 of the first embodiment and a program PR2 is used in place of the program PR1 of the first embodiment.

The TOF sensor 19 is a time-of-flight sensor, and measures the shape of the screen surface SC. The output of the TOF sensor 19 indicates the three-dimensional coordinates of the screen surface SC.

The processing device 12 of the embodiment functions as a plane detection unit 12d, the axis calculation unit 12b, and the correction value calculation unit 12c by executing the program PR2 stored in the storage device 11. Accordingly, the processing device 12 of the embodiment includes the plane detection unit 12d, the axis calculation unit 12b, and the correction value calculation unit 12c.

The plane detection unit 12d obtains a plane representing the screen surface SC based on the output of the TOF sensor 19. The axis calculation unit 12b of the embodiment obtains the axis x and the axis y as the coordinate axes of the screen surface SC based on the plane obtained by the plane detection unit 12d and the output of the acceleration sensor 18.

FIG. 20 is a flowchart showing a flow of a correction method according to the second embodiment. The correction method is executed by the above described projector 10A.

As shown in FIG. 20, the correction method of the embodiment is the same as the correction method of the first embodiment except that step S10A is provided in place of step S10 of the first embodiment. Step S10A is the same as step S10 of the first embodiment except that step S12A is provided in place of steps S11 and S12 of the first embodiment.

At step S12A, the plane detection unit 12d measures the shape of the screen surface SC using the TOF sensor 19, and obtains the coordinates on the screen surface SC based on the output of the TOF sensor 19. At step S13 of the embodiment, the plane detection unit 12d obtains a plane representing the screen surface SC based on the coordinates obtained at step S12A.

According to the second embodiment, the correction accuracy of the shape of the projected image may be increased. As described above, the correction method of the embodiment includes step S10A and, at step S10A, the plane of the screen surface SC is obtained using the TOF sensor 19 as the time-of-flight sensor. Thereby, compared with the mode using the measurement pattern PT like the first embodiment, the plane representing the screen surface SC can be obtained in a shorter time.

### 3. Third Embodiment

A third embodiment of the present disclosure will be described as below. In the embodiment exemplified below, the reference signs used in the description of the first embodiment are used for elements having the same actions and functions as those of the first embodiment, and the detailed description of the respective elements is omitted as appropriate.

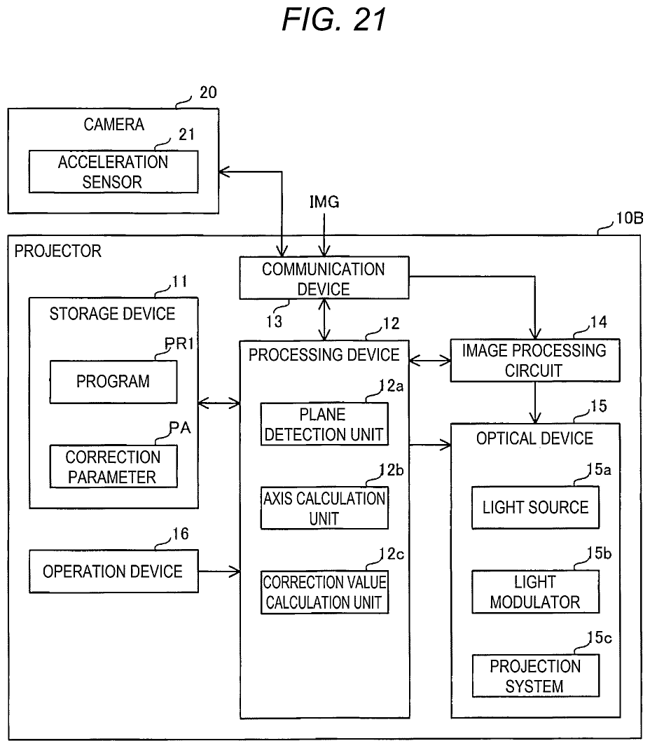

FIG. 21 is a block diagram of a projector 10B according to the third embodiment. The projector 10B has the same configuration as the projector 10 of the first embodiment except that the camera 17 and the acceleration sensor 18 of the first embodiment are omitted. However, a camera 20 is communicably connected to the projector 10B.

The camera 20 has the same configuration as the camera 17 of the first embodiment except that the camera 20 is provided outside the projector 10B and includes an acceleration sensor 21. The acceleration sensor 21 has the same configuration as the acceleration sensor 18 of the first embodiment except that the acceleration sensor 21 is provided in the camera 20. Here, the acceleration sensor 21 outputs signals corresponding to accelerations in directions along the respective axes of the x-axis, the y-axis, and the z-axis associated with the coordinate system of the optical device 15 of the projector 10B. The camera 20 may be calibrated for specification of a positional relationship with the projector 10B in advance, and associated with the coordinate system of the optical device 15 of the projector 10B based on the specified positional relationship.

According to the third embodiment, the correction accuracy of the shape of the projected image may be increased. In the embodiment, as described above, the acceleration sensor 21 is disposed in the camera 20 that images the measurement pattern PT. Thereby, the functions of the acceleration sensor 21 and the camera 20 can be easily added even when the projector 10B is not provided with the acceleration sensor or the camera.

### 4. Modified Examples

The embodiments exemplified above can be variously modified. Specific configurations of modifications applicable to the above described embodiments will be exemplified below. Two or more configurations optionally selected from the following exemplifications can be combined as appropriate as long as the configurations are mutually consistent.

### 4-1. Modified Example 1

In the above described first embodiment, the acceleration sensor 18 is provided in the projector 10, however, the acceleration sensor 18 may be provided outside the projector 10. Also in this case, the acceleration sensor 18 is associated with the coordinate system of the optical device 15 of the projector 10. Similarly, in the second embodiment, the acceleration sensor 18 may be provided outside the projector 10A.

### 4-2. Modified Example 2

In the above described first embodiment, the camera 17 is provided in the projector 10, however, the camera 17 may be provided outside the projector 10. Similarly, in the second embodiment, the camera 17 may be provided outside the projector 10A.

### 5. Appendices

As below, a summary of the present disclosure will be appended.

(Appendix 1) A correction method includes obtaining a normal vector of a screen surface, obtaining a first vector orthogonal to both a gravity vector obtained from output of an acceleration sensor associated with a coordinate system of an optical device of a projector and the normal vector, obtaining a second vector orthogonal to the first vector in the screen surface, and obtaining a correction parameter for correction of a shape of a projected image projected on the screen surface based on the first vector and the second vector.

In the above described configuration, the gravity vector and the normal vector are used, and thereby, the correction parameter in consideration of the inclination of the screen surface with respect to the gravity direction may be obtained. As a result, the correction accuracy of the shape of the projected image can be increased.

(Appendix 2) The correction method according to Appendix 1 further includes obtaining a plane representing the screen surface, wherein obtaining the normal vector includes obtaining the normal vector from the plane. In the above described configuration, the normal vector of the screen surface can be easily obtained even when the screen surface is not strictly flat.

(Appendix 3) In the correction method according to Appendix 2, obtaining the plane includes obtaining the plane based on an image obtained by imaging of a measurement pattern projected on the screen surface. In the above described configuration, the plane representing the screen surface can be obtained with high accuracy.

(Appendix 4) In the correction method according to Appendix 3, the acceleration sensor is provided in a camera that images the measurement pattern. In the above described configuration, the functions of the acceleration sensor and the camera can be easily added even when a projector is not provided with the acceleration sensor or the camera.

(Appendix 5) In the correction method according to Appendix 2, obtaining the plane includes obtaining the plane using a time-of-flight sensor. In the above described configuration, the plane representing the screen surface can be obtained in a shorter time compared with the configuration using the measurement pattern.

(Appendix 6) In the correction method according to any one from Appendix 1 to Appendix 5, obtaining the correction parameter includes obtaining the correction parameter using the first vector and the second vector, which are normalized. In the above described configuration, the aspect ratio of the corrected shape can be easily adjusted.

(Appendix 7) A projector includes an optical device, and a processor, and the processor executes obtaining a normal vector of a screen surface, obtaining a first vector orthogonal to both a gravity vector obtained from output of an acceleration sensor associated with a coordinate system of the optical device and the normal vector, obtaining a second vector orthogonal to the first vector in the screen surface, and obtaining a correction parameter for correction of a shape of a projected image projected on the screen surface based on the first vector and the second vector.

In the above described configuration, the gravity vector and the normal vector are used, and thereby, the correction parameter in consideration of the inclination of the screen surface with respect to the gravity direction may be obtained. As a result, the correction accuracy of the shape of the projected image can be increased.

(Appendix 8) A non-transitory computer-readable storage medium storing a program, the program is for controlling a computer to execute obtaining a normal vector of a screen surface, obtaining a first vector orthogonal to both a gravity vector obtained from output of an acceleration sensor associated with a coordinate system of an optical device of a projector and the normal vector, obtaining a second vector orthogonal to the first vector in the screen surface, and obtaining a correction parameter for correction of a shape of a projected image projected on the screen surface based on the first vector and the second vector.

In the above described configuration, the gravity vector and the normal vector are used, and thereby, the correction parameter in consideration of the inclination of the screen surface with respect to the gravity direction may be obtained. As a result, the correction accuracy of the shape of the projected image can be increased.

What is claimed is:

1. A correction method comprising:
obtaining a normal vector of a screen surface;
obtaining a first vector orthogonal to both a gravity vector obtained from output of an acceleration sensor associated with a coordinate system of an optical device of a projector and the normal vector;
obtaining a second vector contained in the screen surface and being orthogonal to the first vector; and
obtaining a correction parameter for correction of a shape of a projected image projected on the screen surface based on the first vector and the second vector.

2. The correction method according to claim 1, further comprising obtaining a plane representing the screen surface, wherein
the obtaining the normal vector includes obtaining the normal vector from the plane.

3. The correction method according to claim 2, wherein
the obtaining the plane includes obtaining the plane based on an image obtained by imaging of a measurement pattern projected on the screen surface.

4. The correction method according to claim 3, wherein
the acceleration sensor is disposed in a camera that images the measurement pattern.

5. The correction method according to claim 2, wherein
the obtaining the plane includes obtaining the plane using a time-of-flight sensor.

6. The correction method according to claim 1, wherein
the obtaining the correction parameter includes obtaining the correction parameter using the first vector and the second vector, which are normalized.

7. A projector comprising:
an optical device; and
one or more processors,
the one or more processors executing
obtaining a normal vector of a screen surface,
obtaining a first vector orthogonal to both a gravity vector obtained from output of an acceleration sensor associated with a coordinate system of the optical device and the normal vector,
obtaining a second vector contained in the screen surface and being orthogonal to the first vector, and
obtaining a correction parameter for correction of a shape of a projected image projected on the screen surface based on the first vector and the second vector.

8. A non-transitory computer-readable storage medium storing a program, the program for controlling a computer to execute:
obtaining a normal vector of a screen surface;
obtaining a first vector orthogonal to both a gravity vector obtained from output of an acceleration sensor associated with a coordinate system of an optical device of a projector and the normal vector;
obtaining a second vector contained in the screen surface and orthogonal to the first vector; and
obtaining a correction parameter for correction of a shape of a projected image projected on the screen surface based on the first vector and the second vector.
